(19) United States
(12) Patent Application Publication
(10) Pub. No.: US 2023/0033665 A1
(43) Pub. Date: Feb. 2, 2023

(54) HUNTERS DESCENDER

(71) Applicant: RICARDO A. RODRIGUEZ, MIAMI, FL (US)

(72) Inventor: RICARDO A. RODRIGUEZ, MIAMI, FL (US)

(21) Appl. No.: 17/443,667

(22) Filed: Jul. 27, 2021

(51) Int. Cl. A62B 1/14

(52) U.S. Cl. CPC A62B 1/14

(57) ABSTRACT

A hunter's descender that allows a suspended person to initiate a controlled descent by pulling on a free end of a rope. The hunter's descender defines a shank section that extends outward from the ring. The shank section defines an end that defines a dual hook that points toward the ring. The ring defines a side appendage that extends a distance that is further outward from the ring than the shank section, the side appendage is positioned, either to a left side or a right side of the shank section. The side appendage defines an open semi-circular guide that is configured to allow a rope or line to pass through the open semi-circular guide after the rope is secured on the hunter's descender. An open section of the open semi-circular guide is on a same plane as the dual hook.

### BACKGROUND

The present invention pertains to a hunter's descender that allows a suspended person to initiate a controlled descent by pulling on a free end of a rope.

Many hunters use tree stands to hunt from an elevated position. There are three basic types of tree stands: hang on tree stands; ladder tree stands; and climber tree stands, each has safety requirements. Falls from a tree stand can result in injuries or death.

Hunting safety protocols call for a hunter to use a full body harness with a lanyard attached to a tree belt at the highest possible elevation above the hunter when hunting from a tree stand.

The reason for the protocol is to prevent a major injury or death. It is not uncommon for a hunter to fall from a tree stand and the lanyard prevents the immediate death of the hunter. Yet, the hunter who has fallen from a tree still faces the possibility of suffering a major injury or death. For, often the hunter who falls from the tree stand is not able to reboard his stand.

If the hunter hangs for a prolonged period from the lanyard, then the hunter faces certain injury or death if not released from the lanyard. Once suspended in a full body harness, a person will be subject to suspension trauma, also known as harness hang syndrome (HHS), suspension syndrome, or orthostatic intolerance. This occurs when the human body is held upright without any movement for a period.

When a person is strapped into a harness or tied to an upright object for an extended period, the person will eventually suffer the central ischemic response (commonly known as fainting).

Fainting while remaining vertical increases the risk of death from cerebral hypoxia. Onset of symptoms of cerebral hypoxia may commence a few minutes after hanging. Typical symptoms are pallor, sweating, shortness of breath, blurred vision, dizziness, nausea, hypotension, and numbness of the legs. Eventually, cerebral hypoxia leads to fainting, which in turn may result in death due to oxygen deprivation of the brain.

As of 2009 hunters full body harnesses come with a suspension trauma relief strap. The Suspension Trauma Safety Strap allows the suspended hunter to stand up in their harness and to relieve the pressure being applied to the arteries and veins around the top of the legs. The continuous loop design allows both sides of the harness to relieve the pressure being applied to the legs. The strap accommodates either having one foot or both feet in the loop at a time—it will relieve the pressure to both sides with just one foot in allowing for added movement of the legs. The strap allows for improved circulation in the legs while suspended and waiting for rescue.

To use the strap, which is meant to loop under the feet, a suspended person must first find the strap, properly tie, and adjust to the correct height to properly step into. This may allow the hunter to stand in their harness and relieve the pressure on the legs while waiting for and if rescue arrives.

The present invention provides a hunter's descender that does not require the use of two ropes or straps when a hunter is descending downward from a tree. It is a safety device that eliminates the need of using two ropes or straps when descending from a tree.

### SUMMARY

The present invention is directed to a hunter's descender that allows a suspended person to initiate a controlled descent by pulling on a free end of a rope that is secured on the hunter's descender.

The hunter's descender defines a shank section that extends outward from the ring. The shank section defines an end that defines a dual hook that points toward the ring. The ring defines a side appendage that extends a distance that is further outward from the ring than the shank section, the side appendage is positioned either to a left side or a right side of the shank section. The side appendage defines an open semi-circular guide that is configured to allow a rope or line to pass through the open semi-circular guide after the rope is secured on the hunter's descender. An open section of the open semi-circular guide is on a same plane as the dual hook.

An object of the present invention is to provide a hunter with a hunter's descender that will prevent his injury or death should the hunter fall off his or her tree stand.

Another object of the present invention is to provide a hunter's descender that will allow a hunter to control his or her descent from his or her lanyard should he or she fall of his or her tree stand.

Yet another object of the present invention is to provide a hunter's descender that does not require the use of two straps or ropes to descent from a tree stand.

### DRAWINGS

These and other features, aspects, and advantages of the present invention will become better understood with regards to the following description, appended claims, and drawings where:

FIG. 1 is a side view of the present invention;

FIG. 2 is a perspective view of the present invention;

FIG. 3 is a perspective view of an embodiment of the present invention;

FIG. 4 is a side view of another embodiment of the present invention;

FIG. 5 is a side view of how a rope that is used to secure the present invention is looped prior to inserting within a ring of the present invention;

FIG. 6 is a side view that shows how the rope is placed within the ring and how the rope is secured around the shank section of the present invention;

FIG. 7 is a side view that shows how a lower end of the rope is placed on the open semi-circular guide of the present invention, the figure shows the rope in a locked position; and

FIG. 8 is a side view that shows how the rope is placed in the unlocked position when the lower end of the rope is pulled by the user.

### DESCRIPTION

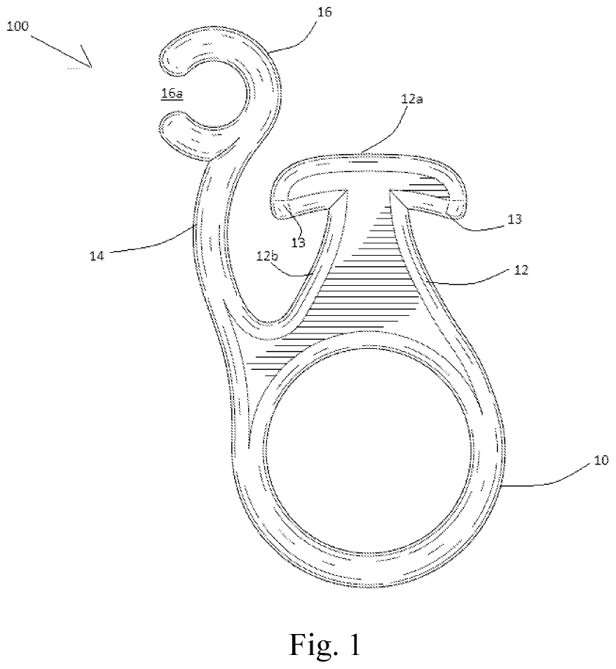

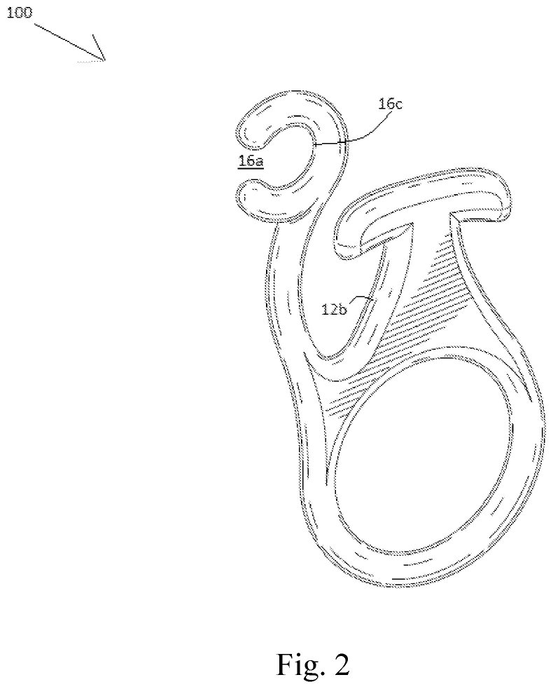

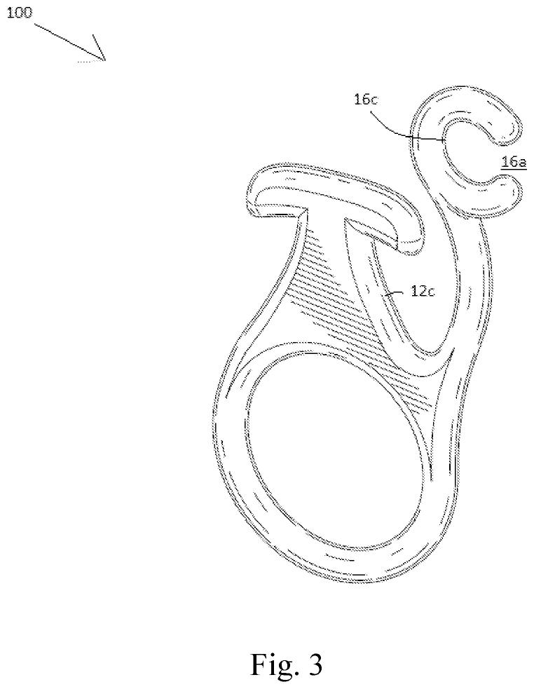

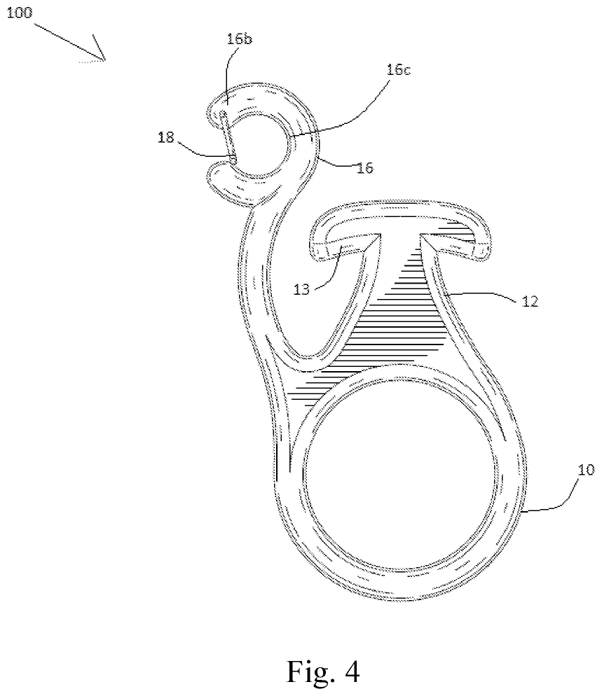

Referring to FIGS. 1-4, the present invention is a hunter's descender 100 that allows a suspended person to initiate a controlled descent by pulling on a free end of a rope.

The hunter's descender comprises of a ring 10 that defines a shank section 12 that extends outward from the ring 10. The shank section 12 has an end 12a that defines a dual hook 13 that points toward the ring 10. The ring 10 has a side appendage 14 that extends for a distance that is further outward from the ring than the shank section, the side appendage 14 is positioned either to a left side 12b or a right side 12c of the shank section 12. The side appendage 14 defines an open semi-circular guide 16 that is configured to allow a rope 200 or line 200 to pass through the open semi-circular-guide 16 after the rope 200 is secured on the hunter's descender 100. An open section 16a of the open semi-circular guide 16 is on a same plane as the dual hook 13, the open section 16a points outwards from the left side 12b or right side 12c of the shank section 12.

In an embodiment of the present invention, the hunter's descender 100 further comprises of a one-way gate 18 that is pivotally attached to an end section 16b of the open semi-circular guide 16. The one-way gate 18 opens inward toward a closed section 16c of the open semi-circular guide 16. The one-way gate 18 is configured to allow a rope 200 not to slip out of the open semi-circular guide 16 when a hunter is using the hunter's descender 100.

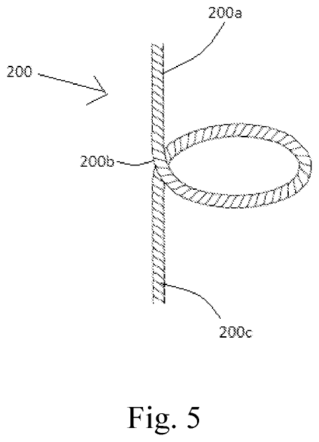

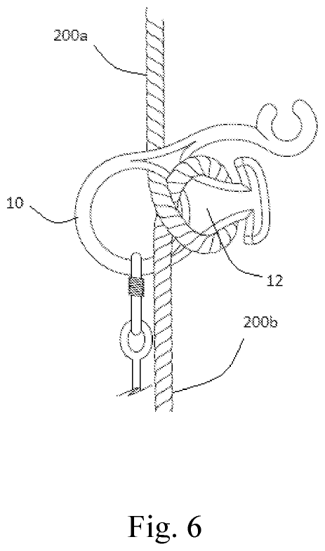

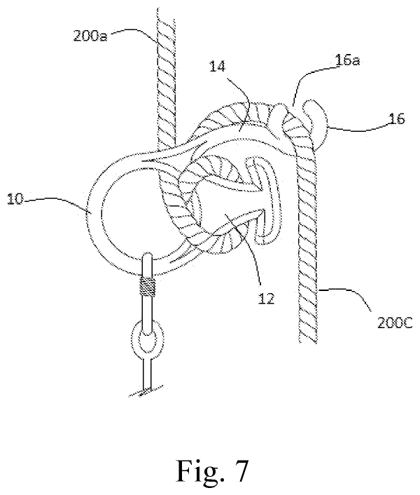

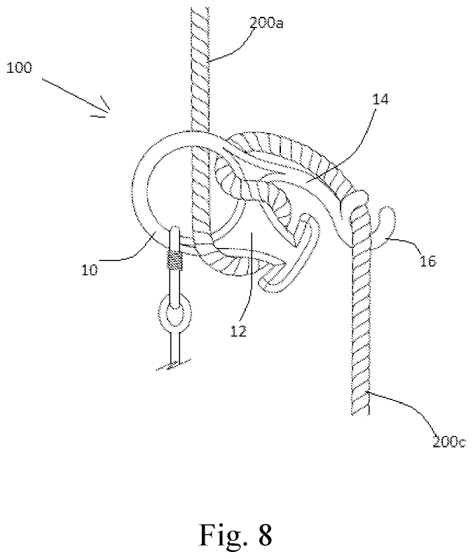

As seen in FIGS. 5-8, the present invention is used in conjunction with a rope 200 as follows: Step 1, an upper section of a rope 200a is secured on a tree and a section of the rope 200b is looped so the upper section 200a of the rope 200 is before a lower section 200c of the rope (as seen in FIG. 5); Step 2, the loop of the rope 200 is inserted so that the upper section 200a of the rope is behind the ring 10 and the lower section 200c is either behind or before the ring 10 after the loop has encircled the shank section 12 of the present invention from the front of the ring 10 (as seen in FIG. 6); Step 3, the lower section 200c of the rope is placed upward toward the appendage 14 of the present invention and through the back of the present invention, the lower end 200c of the rope 200 is placed within the open section 16a of the open semi-circular guide 16 of the present invention and the lower end 200c of the rope 20 rests on the front end of the present invention and the rope 200 hangs downward from the present invention, this is the locked position (as seen in FIG. 7); and Step 4, the rope 200 is placed in the unlocked position when the lower end 200c of the rope 200 is pulled down by the hunter, this is the release or unlocked position that allows the hunter to descent down a tree without the assistance of a second rope or of a rescuer (as seen in FIG. 8). In step 3, the upper end of the rope 200a and the lower end 200c of the rope 200 are in constant contact and therefore the rope is in a locked position. In step 4, the upper end of the rope 200a and the lower end of the rope 200c are not in contact due to the manipulation of the appendage 14 by the hunter when he pulls on the lower end 200c of the rope 200.

An advantage of the present invention is that it provides a hunter with a hunter's descender that prevents his injury or death should the hunter fall off his or her tree stand.

Another advantage of the present invention is that it provides a hunter's descender that allows a hunter to control his or her descent from his or her lanyard should he or she fall of his or her tree stand.

Yet another advantage of the present invention is that it provides a hunter's descender that does not require the use of two straps or ropes to descent from a tree stand.

The embodiments of the hunter's descender described herein are exemplary and numerous modifications, combinations, variations, and rearrangements can be readily envisioned to achieve an equivalent result, all of which are intended to be embraced within the scope of the appended claims. Further, nothing in the above-provided discussions of the hunter's descender should be construed as limiting the invention to an embodiment or a combination of embodiments. The scope of the invention is defined by the description, drawings, and appended claims.

What is claimed is:

1. A hunter's descender that allows a suspended person to initiate, a controlled descent by pulling on the free end of the rope, the hunter's descender comprises:
a ring that defines a shank section that extends outward from the ring, the shank section has an end that defines a dual hook that points toward the ring, and a side appendage that extends outward from the ring for a distance that is further outward from the ring than the shank section and the side appendage is positioned either to a left side or a right side of the shank section, the side appendage defines an open semi-circular guide that is configured to allow a rope or line to pass through the open semi-circular-guide after the rope is secured on the hunter's descender, an open section of the open semi-circular guide is on a same plane as the dual hook, the open section points outwards from the left side or right side of the shank section.

2. The hunter's descender that allows the suspended person to initiate the controlled descent by pulling on the free end of the rope of claim 1, the hunter's descender further comprising of a one-way gate that is pivotally attached to an end section of the open semi-circular guide, the one-way gate opens inward toward a closed section of the open semi-circular guide, the one-way gate is configured to allow the rope not to slip out of the open semi-circular guide when a hunter is using the hunter's descender.
